(19) United States
(12) Patent Application Publication
(10) Pub. No.: US 2026/0181014 A1
(43) Pub. Date: Jun. 25, 2026

(54) INFRASTRUCTURE DISCOVERY SYSTEM AND METHOD

(71) Applicant: Censys, Inc., Ann Arbor, MI (US)

(72) Inventor: Mark Ellzey Thomas, Philadelphia, PA (US)

(21) Appl. No.: 18/988,232

(22) Filed: Dec. 19, 2024

(51) Int. Cl. H04L 9/40

(52) U.S. Cl. CPC H04L 63/1458; H04L 63/1416

(57) ABSTRACT

Hosts forming part of a system, such as C2 hosts in a DDOS system or legitimate network system, may be identified by identifying pivot key-value pairs. An initial set of hosts has a set of first key-value pairs associated therewith, such as from scanning the initial hosts. The key-value pairs may include keys identifying a protocol, field, and/or certificate type and the value may be the information identified by the key. A count of the number of hosts associated with each key-value pair may be calculated. Pivot key-value pairs may be those having counts less than a threshold. Additional hosts may be identified as having the pivot key-value pairs associated therewith.

### FIELD OF THE INVENTION

The present invention relates generally to systems and methods for discovering network infrastructure, such as command and control nodes implementing distributed denial of service (DDOS) attacks.

### BACKGROUND OF THE INVENTION

A DDOS attack is implemented by a plurality of nodes directing traffic at a target of the attack. The objective of the DDOS attack is to overwhelm the target and prevent the target from processing legitimate traffic. A DDOS attack may be implemented by one or more command and control (C2) nodes and many drone nodes. A C2 node may also be used to be used to maintain persistent access to a remote network for non-malicious purposes. In either case, it can be advantageous to detect C2 nodes and categorize them as malicious or performing some other legitimate function.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment for performing infrastructure discovery in accordance with an embodiment of the present invention;

FIG. 2 is a diagram illustrating a record that may be obtained during performance of infrastructure discovery in accordance with an embodiment of the present invention;

FIG. 3 is a process flow diagram of a method for performing infrastructure discovery in accordance with an embodiment of the present invention;

FIG. 4 is a schematic diagram illustrating results of performing infrastructure discovery in accordance with an embodiment of the present invention; and

FIG. 5 is a schematic block diagram of a computing device that may be used to implement the systems and methods described herein.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

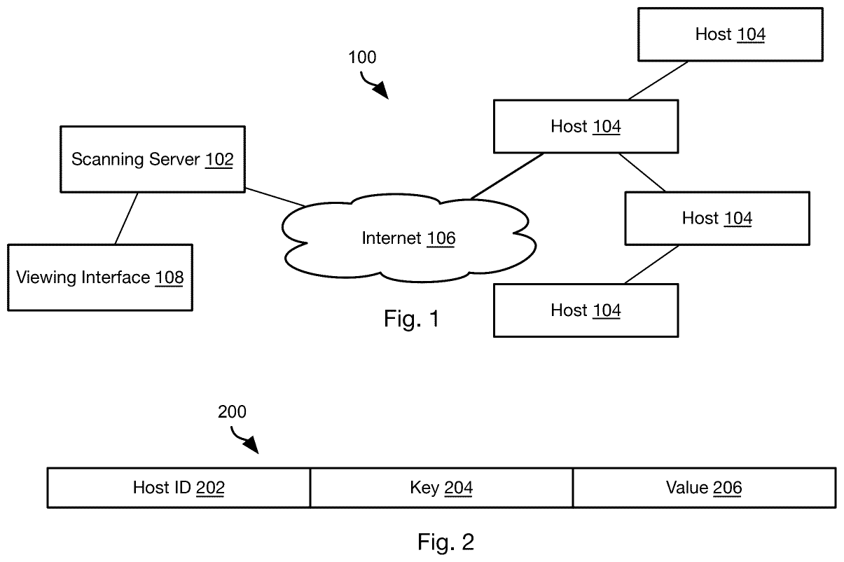

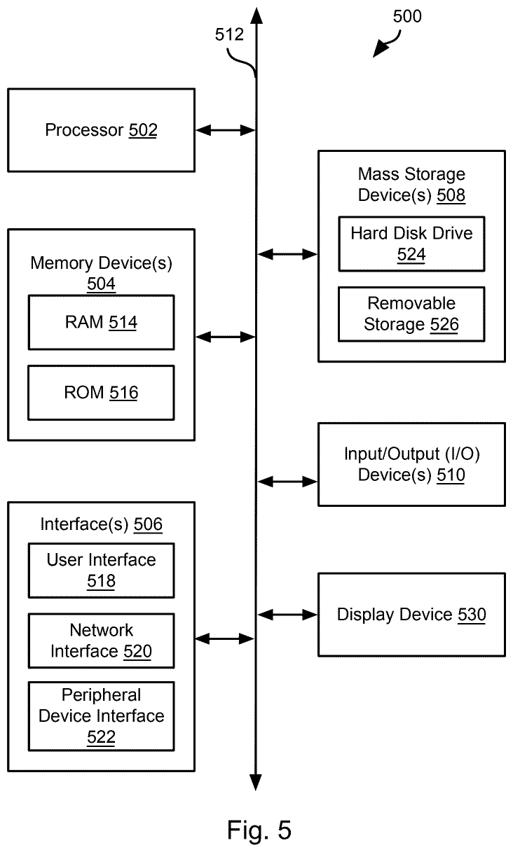

Referring to FIG. 1, a scanning server 102 may be implemented as a computing device, such as a computing device having some or all the attributes of a computing device 500 described below with respect to FIG. 5. The scanning server 102 may scan ports of one or more hosts 104 connected to the scanning server 102 by way of the Internet 106 or other network infrastructure. In particular, using the approach described herein, the scanning server 102 may discover connections between hosts 104.

The scanning server 102 may scan a host 104 by directing probe traffic at various ports of a host 104 according to various protocols, such as hypertext markup language (HTML) transfer protocol (HTTP), HTTP secure (HTTPS), transmission control protocol (TCP), user datagram protocol (UDP), secure shell (SSH), transport layer security (TLS), JavaScript Object Notation (JSON) Web Token (JWT) Secured Authorization Response Mode (JARM).

The scanning server 102 may receive responses to the probe traffic and associate the responses to the probe traffic with an identifier of the host 104, such as one or more of a prefix (e.g., internet protocol (IP) address), domain name, uniform resource locator (URL), or other identifier. For example, data from a response to a probe in the probe traffic may be stored along with other information, such as the port and/or protocol of the probe, the identifier of the host 104, or other information.

Data obtained by the scanning server may be processed and/or output to a viewing interface 108, such as a web page viewable by a web browser, a client application on a user device

Referring to FIG. 2, information obtained by the scanning server 102 in response to a probe of a host 104 may be stored in one or more records 200. Each record may include a host identifier 202 of the host 104 and a key 204 and a value 206 associated with the host identifier 202. A key 204 may include data that defines the role, purpose, context, or other aspect of the value 206. For example, the key 204 may reference a protocol, a field in a protocol header, and/or type of information obtained during a protocol handshake whereas the value 206 is the data included in that field or having the type defined by the key 204. For example, a key 204 may reference any of the fields or type of data exchanged according to HTTP, e.g., response headers, response HTML tags, hash of the body of the HTML document, hash of icons of the HTML document, hash of some other portion of the HTML document, banner data (e.g., in hexadecimal) of an HTML document, or other information exchanged according to HTTP. The value 206 may therefore be the value in the field or the information corresponding to the type indicated in the key 204.

The key 204 may identify a type of certificate according to TLS, e.g., tls.certificates.leaf_data.subject.organization, tls.certificates.leaf_data.subject.common-name, tls.certificates.leaf_data.issuer.common_name, tls.certificates.leaf_data.issuer_dn, and/or tls.certificates.leaf_data, subject_dn. The value 206 may then be the certificate identified by the key 204.

The key 204 may reference a type of data exchanged according to SSH, sch as a type of a host key (e.g., fingerpring_sha256). The value 206 may then be the data having that type. The key 204 may identify an executable used to perform a scan and the value 206 may be data obtained using the executable.

The examples above are for illustration only. Any type of information obtained from scanning a host 104 may be used as the key 204 and the information having that type may be the corresponding value 206 for that key 204. The methods disclosed herein may be performed with respect to data describing a host obtained using any scanning approach or other approach for obtaining information about a host and are therefore independent of the approach by which records 200 are obtained.

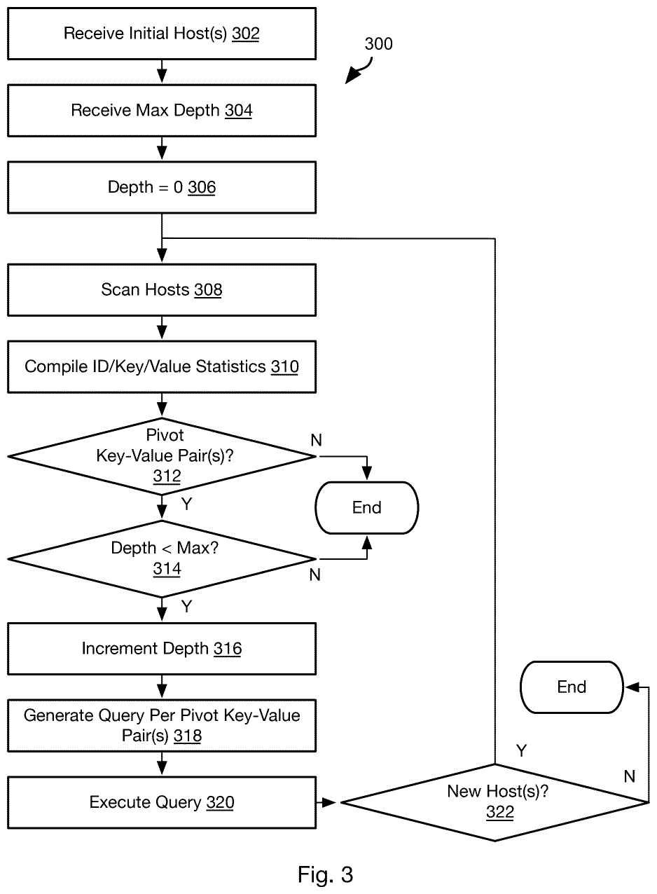

FIG. 3 illustrates a method 300 that may be performed using records 200 in order to identify hosts 104 and relationships between hosts.

The method 300 may include receiving 302 a set of one or more initial host identifiers. The one or more initial host identifiers may, for example, be a known command and control (C2) or drone node of a DDOS installation. The manner in which the initial host identifiers are obtained may be according to any approach known in the art for identifying malicious nodes over a network. The initial hosts may therefore be identified using any approach for detecting and/or preventing DDOS attacks, detecting hosts contacted by viruses or malware, detecting any other sort of attack by a host 104, or detecting an attempt by a host 104 to exfiltrate data.

The method 300 may include receiving 304 a max depth. As described below for each host 104 (either an initial host 10 or a host discovered according to the method 300), the method 300 may include attempting to identifying one or more new hosts 104. The max depth may therefore indicate the number of times to repeat the process of identifying new hosts based on hosts identified in a previous iteration of the process. The current depth (e.g., number of times the process has been performed) may be initialized 306 to zero.

The method 300 may include scanning 308 a current set of hosts 104 to obtain records 200 for each of host of the current set of hosts 104. For a first iteration, the current set of hosts 104 is the initial hosts 104 from step 302. Scanning of step 308 may be performed using any of the approaches described above with respect to FIGS. 1 and 2.

The method 300 may include compiling 310 statistics for the records 200. For example, step 310 may include obtaining a count of the number of unique host identifiers 202 listed in the records 200 from step 308 that have the same key 204 and value 206. The result of step 310 may therefore include a plurality of statistical entries, each statistical entry including a key 204 and a value 206 and the count from step 310 for that key 204 and value 206.

The method 300 may include evaluating, at step 312, the statistical entries to identify pivot key-value pairs. In particular, pivot key-value pairs may be selected based on rarity: the combinations of key 204 and value 206 that are relatively less frequently occurring may be deemed more significance. In some embodiments, pivot key-value pairs are selected as the key 204 and value 206 of those statistical entries having counts below a threshold. The threshold may be a static threshold, such as 200, 150, 100, 50, 20, or some other value. The threshold may be dynamic, such as selecting as the pivot key-value pairs any key 204 and value 206 pairs having the bottom N counts, or bottom X percent of counts, where N is a predefined integer and X is a predetermined value, such as 25, 12, 10, 5, 2, or some other value. The threshold may be obtained from a statistical characterization: the pivot key-value pairs any key 204 and value 206 pairs having counts that are Y standard deviations below a mean, where Y is a predetermined value, such as at least 1, 2, 3, or some larger value, and the standard deviation is the standard deviation of the counts of the statistical entries, and the mean is the mean of the counts of the statistical entries.

If no pivot key-value pairs are identified the method 300 may end. If the depth is not found 314 to be less than the max depth, the method 300 may also end.

If one or more pivot key-value pairs are identified at step 312 and the depth is found 314 to be less than the max depth, the method 300 may include incrementing 316 the depth and generating 318 a query according to the pivot key-value pairs from step 312. The query may be executed 320. The results of executing the query may be evaluated at step 322 to determine whether the results indicate any new hosts 104, e.g., that are not the initial hosts 104 or hosts 104 identified in a previous iteration of step 322. For example, the query generated at step 318 may query the records 200 for to obtain the host identifiers 202 of records 200 having the one or more pivot key-value pairs identified at step 312 and for which the host identifiers 202 thereof do not match the initial hosts 104 or any of the hosts 104 identified in prior iterations of step 322. Steps 318, 320, 322 describe the use of queries to identify new hosts 104. However, other approaches may also be used.

If no new hosts are found at step 322, the method 300 may end. If new hosts are found, the method may continue at step 308 with the current set of hosts set to be the new hosts identified at step 322.

The method 300 is exemplary only and various modifications may be performed. For example, the method 300 may being with receiving an initial set of one or more pivot key-value pairs identified from scanning a host 104 or some other approach. For example, the initial set of one or more key-value pairs may be determined to be of interest and be used to identify infrastructure (e.g., hosts 104) relevant to that initial set of one or more key-value pairs according to the method 300. For example, processing may begin at step 318 for the initial set of one or more key-value pairs and then continue as described above.

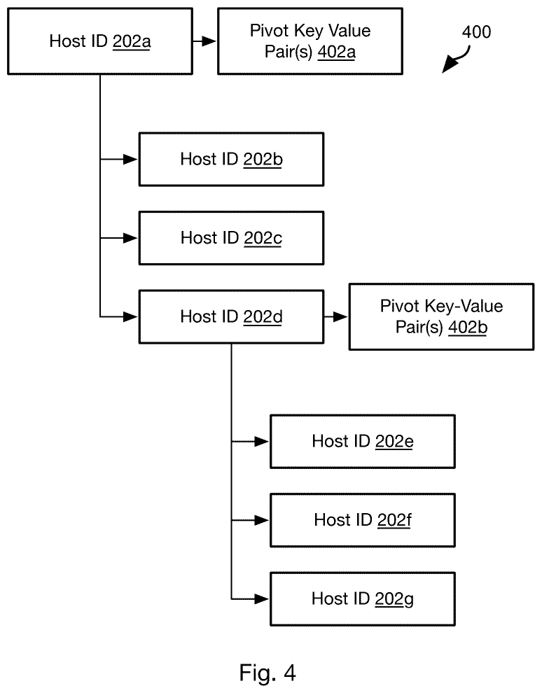

FIG. 4 illustrates a representation 400 of data that may be obtained according to the method 300. For example, host identifier (ID) 202a may be the identifier of an initial host 104. Pivot key-value pairs 402a may be associated with the host identifier 202a. Pivot key-value pairs 402a may be pivot key-value pairs 402a identified according to the method 300 and included in one or more records 200 including the host identifier 202a.

The host identifier 202a may be connected to one or more other host identifiers 202b, 202c, 202d in the representation 400, e.g., an edge in a directed acyclic graph representation, a parent-child relationship in a hierarchy, or other logical association. The other host identifiers 202b, 202c, 202d may be hosts for which records 200 were found that include the host identifiers 202b, 202c, 202d and at least one of the pivot key-value pairs 402a.

The representation 400 may include any number of levels, such as up to the max depth of the method 300. Accordingly, any of the host identifiers 202b, 202c, 202d may have pivot key-value pairs 402b associated therewith along with connections to one or more other host identifiers 202e, 202f, 202g. The other host identifiers 202e, 202f, 202g may be hosts for which records 200 were found that include the host identifiers 202e, 202f, 202g and at least one of the pivot key-value pairs 402b.

The representation 400 may be used for various purposes. For example, the representation 400 may be displayed using the viewing interface 108. Hosts 104 may be labeled in a database according to the representation 400, e.g., to indicate that the host is part of a DDOS installation represented by the representation 400. Actions may be taken with respect to a hosts 104 in response to the host 104 being identified according to the method 300, such as blocking, redirecting, or inspecting traffic from such as host 104.

FIG. 5 illustrates an example computing device 500 that may be used to implement the scanning server 102, host 104, or viewing interface 108. The computing device 500 may be used to implement the method 300.

Computing device 500 includes one or more processor(s) 502, one or more memory device(s) 504, one or more interface(s) 506, one or more mass storage device(s) 508, one or more Input/Output (I/O) device(s) 510, and a display device 530 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 include any number of different network interfaces 520, such as interfaces to local area networks (LANs), wide area networks (WANs), wireless networks, and the Internet. Other interface(s) include user interface 518 and peripheral device interface 522. The interface(s) 506 may also include one or more user interface elements 518. The interface(s) 506 may also include one or more peripheral interfaces such as interfaces for printers, pointing devices (mice, track pad, etc.), keyboards, and the like.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
receiving, by a computer system, a plurality of first key-value pairs each associated with at least one first host of a plurality of first hosts;
calculating, by the computer system, for each first key-value pair of the plurality of first key-value pairs, a count of hosts of those of the plurality of first hosts that are associated with the each first key-value pair;
identifying, by the computer system, one or more pivot key-value pairs of the plurality of first key-value pairs, the count of each pivot key-value pair of the one or more pivot key-value pairs being below a threshold;
scanning, by a computer system, a plurality of second hosts, to obtain a plurality of second key-value pairs each associated with at least one second host of the plurality of second hosts;
identifying, by the computer system, a portion of the plurality of second hosts having at least one of the one or more pivot key-value pairs associated therewith; and
labeling, by the computer system, the portion of the plurality of second hosts as having a connection to at least one host of the plurality of first hosts having the at least one of the one or more pivot key-value pairs associated therewith.

2. The method of claim 1, wherein the plurality of first key-value pairs and the plurality of second key-value pairs each include a key that identifies a protocol and a value according to the protocol.

3. The method of claim 1, wherein the plurality of first key-value pairs and the plurality of second key-value pairs each include a key that identifies a protocol and a field according to the protocol and a value received in the field according to the protocol.

4. The method of claim 1, wherein the plurality of first key-value pairs and the plurality of second key-value pairs each include a key that identifies a certificate according to a protocol and a value including the certificate according to the protocol.

5. The method of claim 1, wherein the plurality of first key-value pairs and the plurality of second key-value pairs each include a key that identifies a protocol and a port number and a value received from the port number according to the protocol.

6. The method of claim 1, wherein scanning the plurality of second hosts comprises scanning the plurality of second hosts according to one or more protocols.

7. The method of claim 6, wherein the one or more protocols include hypertext markup language (HTML) transfer protocol (HTTP), HTTP secure (HTTPS), transmission control protocol (TCP), user datagram protocol (UDP), secure shell (SSH), transport layer security (TLS), or JavaScript Object Notation (JSON) Web Token (JWT) Secured Authorization Response Mode (JARM).

8. The method of claim 6, wherein the one or more protocols include two or more of hypertext markup language (HTML) transfer protocol (HTTP), HTTP secure (HTTPS), transmission control protocol (TCP), user datagram protocol (UDP), secure shell (SSH), transport layer security (TLS), or JavaScript Object Notation (JSON) Web Token (JWT) Secured Authorization Response Mode (JARM).

9. The method of claim 1, wherein labeling the portion of the plurality of second hosts comprises labeling the portion of the plurality of second hosts as part of a distributed denial of service (DDOS) system.

10. The method of claim 1, wherein the plurality of first hosts are command and control (C2) nodes of the DDOS system.

11. A system comprising:
one or more processing devices; and
one or more memory devices operably coupled to the one or more memory devices, the one or more memory devices storing executable code that, when executed by the one or more processing devices, causes the one or more processing devices to:
receive a plurality of first key-value pairs each associated with at least one first host of a plurality of first hosts;
calculate, for each first key-value pair of the plurality of first key-value pairs, a count of hosts of those of the plurality of first hosts that are associated with the each first key-value pair;
identify one or more pivot key-value pairs of the plurality of first key-value pairs, the count of each pivot key-value pair of the one or more pivot key-value pairs being below a threshold;
scan a plurality of second hosts, to obtain a plurality of second key-value pairs each associated with at least one second host of the plurality of second hosts;
identify a portion of the plurality of second hosts having at least one of the one or more pivot key-value pairs associated therewith; and
label the portion of the plurality of second hosts as having a connection to at least one host of the plurality of first hosts having the at least one of the one or more pivot key-value pairs associated therewith.

12. The system of claim 11, wherein the plurality of first key-value pairs and the plurality of second key-value pairs each include a key that identifies a protocol and a value according to the protocol.

13. The system of claim 11, wherein the plurality of first key-value pairs and the plurality of second key-value pairs each include a key that identifies a protocol and a field according to the protocol and a value received in the field according to the protocol.

14. The system of claim 11, wherein the plurality of first key-value pairs and the plurality of second key-value pairs each include a key that identifies a certificate according to a protocol and a value including the certificate according to the protocol.

15. The system of claim 11, wherein the plurality of first key-value pairs and the plurality of second key-value pairs each include a key that identifies a protocol and a port number and a value received from the port number according to the protocol.

16. The system of claim 11, wherein the executable code, when executed by the one or more processing devices, further causes the one or more processing devices to scan the plurality of second hosts by scanning the plurality of second hosts according to one or more protocols.

17. The system of claim 16, wherein the one or more protocols include at least one of hypertext markup language (HTML) transfer protocol (HTTP), HTTP secure (HTTPS), transmission control protocol (TCP), user datagram protocol (UDP), secure shell (SSH), transport layer security (TLS), or JavaScript Object Notation (JSON) Web Token (JWT) Secured Authorization Response Mode (JARM).

18. The system of claim 16, wherein the one or more protocols include two or more of hypertext markup language (HTML) transfer protocol (HTTP), HTTP secure (HTTPS), transmission control protocol (TCP), user datagram protocol (UDP), secure shell (SSH), transport layer security (TLS), or JavaScript Object Notation (JSON) Web Token (JWT) Secured Authorization Response Mode (JARM).

19. The system of claim 11, wherein the executable code, when executed by the one or more processing devices, further causes the one or more processing devices to label the portion of the plurality of second hosts by labeling the portion of the plurality of second hosts as part of a distributed denial of service (DDOS) system.

20. The system of claim 11, wherein the plurality of first hosts are command and control (C2) nodes.
